(19) United States
(12) Patent Application Publication
(10) Pub. No.: US 2009/0063505 A1
(43) Pub. Date: Mar. 5, 2009

(54) Selective chaining of LDAP directory servers

(76) Inventor: Nathan G. Kinder, Castro Valley, CA (US)

Correspondence Address: RED HAT/BSTZ;BLAKELY SOKOLOFF TAYLOR & ZAFMAN LLP, 1279 OAKMEAD PARKWAY, SUNNYVALE, CA, 94085-4040, US

(21) Appl. No.: 11/897,462

(22) Filed: Aug. 30, 2007

(51) Int. Cl. G06F 17/30

(52) U.S. Cl. 707/10; 707/E17.01

(57) ABSTRACT

A method and apparatus for selective chaining Light Weight Directory Access Protocol (LDAP) servers in response to an LDAP request. In one embodiment, the method comprises receiving, at a directory server, a request pertaining to an LDAP entry, the request indicating a read or write operation for the LDAP entry. The method further determining a destination server based on a forwarding policy that is independent of a suffix of the LDAP entry and the read or write operation. The directory server then forwards the request to the destination server.

### TECHNICAL FIELD

Embodiments of the present invention relate to Lightweight Directory Access Protocol (LDAP), and more specifically, to selective chaining of LDAP directory servers in response to an LDAP request.

### BACKGROUND

Light Weight Directory Access Protocol (LDAP) has become very popular due to its efficient and fast data access. A large number of applications/services are currently being developed which use an LDAP directory as their centralized data repository.

In the LDAP directory, data is stored as a tree of entries, with each entry including key/value pairs. A key/value pair may consist of an attribute name and an attribute value. For example, an entry representing a person may include the textual string “telephoneNumber” as the attribute name and the numeric string “+1 800 123 4567” as the attribute value.

An LDAP directory can be queried to provide an attribute value of an LDAP entry. LDAP entries can also be written (e.g., added, modified, or deleted) in response to a write request. When a client submits a read or write request to an LDAP directory server and the server cannot satisfy the request directly, the server may have information about a different server that can provide the requested response. The server may return to the client a referral, including the address of the server that can satisfy the request. Alternatively, the server that cannot satisfy the request can forward the request to another server on the behalf of the client, and return the result to the client. The operation of forwarding a request from a server to another server is referred to as server chaining.

Currently, the server-to-server chaining performed by LDAP directory servers is based on a suffix of the requested LDAP entry, the type of the requested operation, or a combination of both. The suffix of an LDAP entry indicates where the entry is in the directory tree structure; specifically, to which subtree the entry belongs. Thus, based on the current techniques, different servers can be configured to hold different subtrees of the overall directory tree structure. With respect to the type of request operation, the current techniques generally perform a read operation at the local server and only forward a write operation. The forwarding destination of a write operation can depend on whether the write operation is an add, a delete, or a modify operation. This provides limited flexibility in the selection of forwarding destinations. Thus, a system administrator can do little to manage where particular directory operations are to be performed.

### BRIEF DESCRIPTION OF THE DRAWINGS

The present invention is illustrated by way of example, and not by way of limitation, in the figures of the accompanying drawings and in which:

FIG. 1 illustrates a network architecture in which embodiments of the present invention may be implemented.

FIG. 2 is a block diagram of a Light Weight Directory Access Protocol (LDAP) directory server coupled to an LDAP repository to perform server chaining.

FIG. 3 illustrates an example of a forwarding map used for determination of a forwarding destination.

FIG. 4 is a flow diagram of one embodiment of a process of server chaining.

FIG. 5 illustrates a block diagram of an exemplary computer system implementing some embodiments of the present invention.

### DETAILED DESCRIPTION

Described herein is a method and apparatus for selectively chaining Light Weight Directory Access Protocol (LDAP) directory servers in response to an LDAP request. In one embodiment, an LDAP directory server has access to information about other servers to which a request can be forwarded. The information may be stored as a forwarding map based on forwarding policies that are independent of a suffix of the LDAP entry and the read/write operation specified in the request. The forwarding map may be predefined for a director server or created by a system administrator, and may be dynamically updated by the system administrator. When the directory server receives a request from a client and determines that it cannot satisfy the request, the directory server forwards the request to the destination server indicated by the forwarding map and returns the response from the destination server to the client.

Embodiments of the technique described herein may perform server chaining based on a characteristic of the source of the request, such as the Berkeley Internet Name Domain (BIND) domain name server (DNS) used in the request, the client's Internet Protocol (IP) address or host name, client's group membership, and the like. The server chaining may also be based on one or more object classes of the requested LDAP entry. An object class of an LDAP entry defines what kind of object the entry represents, e.g., a person, organization, or domain, and defines which attributes the entry may contain and which attributes the entry is required to contain. The server chaining technique described herein is independent of a suffix of the requested LDAP entry and the operation (e.g., read or write) to be performed on the entry. Thus, the determination of where to forward a request is flexible and can be easily managed by a system administrator to adapt to changing environments.

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving”, “determining”, “forwarding”, “maintaining”, “updating”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description below. In addition, the present invention is not described with reference to any particular programming language. It will be appreciated that a variety of programming languages may be used to implement the teachings of the invention as described herein.

A machine-accessible storage medium includes any mechanism for storing or transmitting information in a form readable by a machine (e.g., a computer). For example, a machine-accessible storage medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

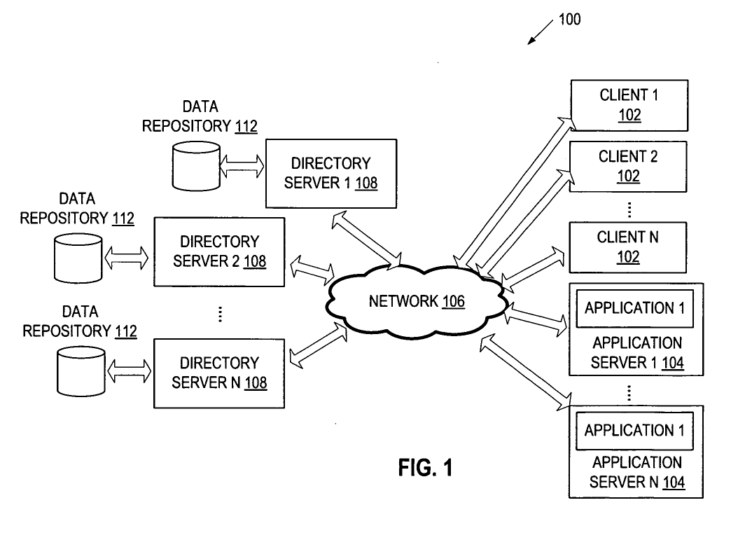

FIG. 1 illustrates an exemplary network architecture 100 in which embodiments of the present invention may operate. The network architecture 100 may include client devices (clients) 102, directory servers 108 and a network 106. The clients 102 may be, for example, personal computers (PCs), mobile phones, palm-sized computing devices, personal digital assistants (PDAs), and the like.

In one embodiment, the directory servers 108 may be Light Weight Directory Access Protocol (LDAP) directory servers. Each directory server 108 may contain a server front end responsible for network communications, plugins for server functions (such as access control and replication), a basic directory tree containing server-related data, and a database back end plugin responsible for managing the storage and retrieval of repository data.

The clients 102 are coupled to the directory server 108 via the network 106, which may be a public network (e.g., Internet) or a private network (e.g., Ethernet or a local area Network (LAN)). In one embodiment, the clients 102 communicate with the directory servers 108 via a web server (not shown). For example, the clients 102 may host web browsers that communicate with the web server using HTTP to request information. The web server may then communicate with the directory servers 108 to retrieve requested information from data repositories 112. Alternatively, the clients 102 may communicate directly with one of the directory servers 108 to request information stored in its associated data repository 112.

The network architecture 100 may also include one or more application servers 104 that host various applications requesting information from the directory servers 108. The application servers 104 operate as clients in communication with the directory servers 108. Similarly to the clients 102, the application servers 104 may communicate with the directory servers 108 directly or via a web server.

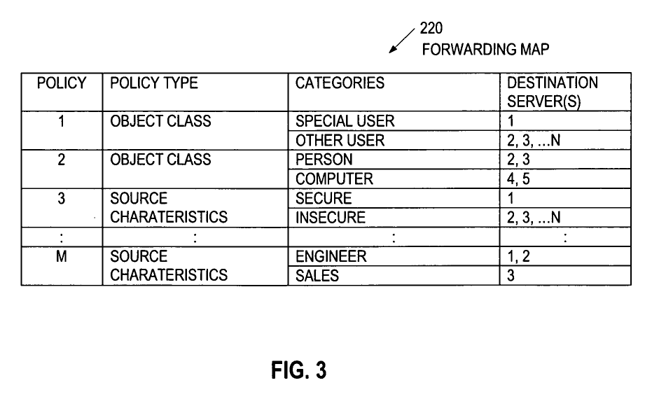

Each data repository 112 may be part of its associated directory server 108, or it may reside externally (e.g., on a database server). Each data repository 112 may contain a tree of LDAP entries, with each entry including a collection of attribute names and attribute values. The data repositories 112 may store the same LDAP entries; alternatively, some or all of the data repositories 112 may store different LDAP entries according to the policies to be described in detail with reference to FIG. 3.

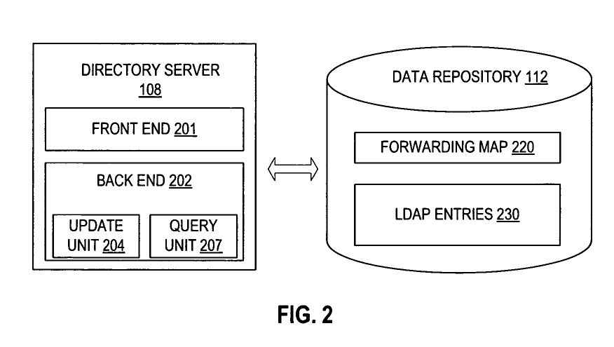

FIG. 2 illustrates an embodiment of one of the directory servers 108 and its associated data repository 112. The directory server 108 includes a front end 201 and a back end 202. The front end 201 determines the type of an incoming request (e.g., a search request or an update request) and passes the parsed information to the back end 202. The back end 202 of the directory server 108 includes an update unit 204 to perform update operations (e.g., add, delete, or modify) to the LDAP entries 230, and a query unit 207 to perform search operations. In response to a search request, the back end 202 returns retrieved values to the front end network interface for transmitting a reply to the source of the request (e.g., the client 102).

In one embodiment, the data repository 112 stores a forwarding map 220 created based on forwarding policies that are independent of the suffix of the LDAP entries 230 and the operation (e.g., read or write) to be performed on the LDAP entries 230. In alternative embodiments, the forwarding map 220 may be stored in the main memory or other memory devices accessible to the directory server 108. The forwarding map 220 contains information for the directory server 108 to determine whether to forward a request, and, if the request is to be forwarded, to which destination server the request should be forwarded. The forwarding map 220 may include a plurality of forwarding policies. Each forwarding policy maps a category of requests to one or more forwarding destinations. Forwarding policies may be specified by a system administrator (e.g., based on selection from a list of predefined default policies) and dynamically updated by the system administrator. The directory server 108 may be configured to choose a forwarding policy for a particular request based on a characteristic of the source of the request, an object class of the requested entry, the service quality of the forwarding destination, or a combination of some or all of the above.

For example, a request may be forwarded to another directory server 108 based on where the request comes from, as indicated by, e.g., the host name, the Internet Protocol (IP) address, the type of login account, the connection of the source (e.g., a digital subscriber line (DSL), cable, or a 56K modem). A request may be forwarded based on a group membership (e.g., engineering unit vs. sales, authorized vs. anonymous, etc.) of the source. A request may also be forwarded based on a security level of the source (e.g., a public terminal or a secured terminal).

Moreover, a request may be forwarded based on an object class of the requested entry. For example, the LDAP entries 230 representing a user may include an object class “special user” to indicate a special status of the entry. The directory server 108 may forward a request for information about a special user to a destination different from the destination for other requests.

In some embodiments, the decision on where to forward a request is also dependent on the service quality of the forwarding destination. For example, a request for an entry having the “special user” object class may be forwarded to a destination server that has a shorter response time, a more powerful processor and/or a lighter load compared to the destination server for other requests. When the service quality of the destination servers change, the forwarding map 220 may be updated dynamically to reflect the changed conditions.

FIG. 3 illustrates an example of the forwarding map 220. In this embodiment, the forwarding map 220 is organized as a table. Alternatively, other data structures may be used. The forwarding map 220 includes policy identifiers, request categories, destination server identifiers, and, optionally, annotations (such as policy types). Each policy identifier corresponds to a forwarding policy that maps a request category to one or more destination servers. For example, policy #1 indicates that requests having the “special user” object class are to be forwarded to destination server #1, and requests not having the “special user” object class are to be forwarded to other destination servers. Policy #3 indicates that requests coming from a secure connection (e.g., the secure sockets layer (SSL)) are to be forwarded to destination server #1, and requests coming from an insecure connection are to be forwarded to other destination servers. In one embodiment, the directory server 108 can be configured dynamically at runtime to adopt one or more of the policies indicated in the forwarding map 220.

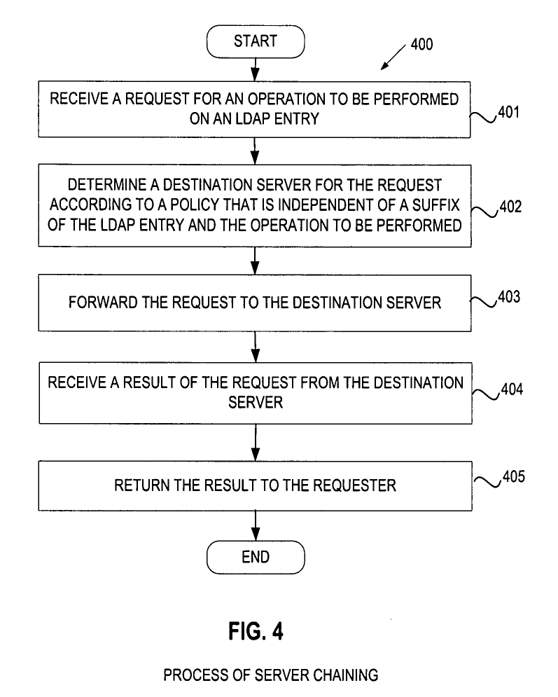

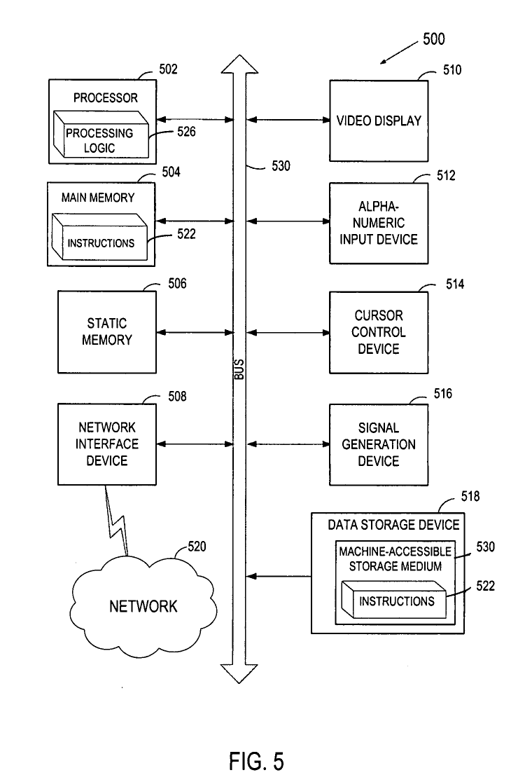

FIG. 4 illustrates a flow diagram of one embodiment of a process 400 for performing server chaining. The process 400 may be performed by processing logic 526 of FIG. 5 that may comprise hardware (e.g., circuitry, dedicated logic, programmable logic, microcode, etc.), software (such as instructions run on a processing device), or a combination thereof. In one embodiment, the process 400 is performed by any directory server 108 of FIG. 1 to forward a request to one of any other directory servers 108.

Referring to FIG. 4, at block 401, the process 400 begins with the processing logic 526 receiving a request for an LDAP entry. In response to the request, at block 402, the processing logic 526 determines a forwarding destination to forward the request. In one embodiment, the determination is made by consulting the forwarding map 220 of FIGS. 2 and 3, which is created based on forwarding policies independent of the suffix of the request and the read/write operation to be performed. The processing logic 526 may be configured to adopt one or more of the forwarding policies specified in the forwarding map 220. According to the configured policies, at block 403, the request is forwarded to the forwarding destination. At block 404, the result of the request is received from the forwarding destination. At block 405, the result is returned to the requesting client.

FIG. 5 illustrates a diagrammatic representation of a machine in the exemplary form of a computer system 500 within which a set of instructions, for causing the machine to perform any one or more of the methodologies discussed herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage device 518, which communicate with each other via a bus 530.

Processing device 502 represents one or more general-purpose processing devices such as a microprocessor, central processing unit, or the like. More particularly, the processing device may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. The processing device 502 is configured to execute the processing logic 526 for performing the operations and steps discussed herein.

The computer system 500 may further include a network interface device 508. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 516 (e.g., a speaker).

The data storage device 518 may include a machine-accessible storage medium 530 on which is stored one or more sets of instructions (e.g., software 522) embodying any one or more of the methodologies or functions described herein. The software 522 may also reside, completely or at least partially, within the main memory 504 and/or within the processing device 502 during execution thereof by the computer system 500, the main memory 504 and the processing device 502 also constituting machine-accessible storage media. The software 522 may further be transmitted or received over a network 520 via the network interface device 508.

The machine-accessible storage medium 530 may also be used to store the LDAP entries 230 of FIG. 2. While the machine-accessible storage medium 530 is shown in an exemplary embodiment to be a single medium, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instructions for execution by the machine and that cause the machine to perform any one or more of the methodologies of the present invention. The term “machine-accessible storage medium” shall accordingly be taken to include, but not be limited to, solid-state memories, optical and magnetic media, and carrier wave signals.

Thus, a method and system for selectively chaining LDAP directory servers in response to an LDAP request have been described. It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

What is claimed is:

1. A computer-implemented method comprising:
receiving, at a directory server, a request pertaining to a Light Weight Directory Access Protocol (LDAP) entry, the request indicating a read or write operation for the LDAP entry;
determining a destination server based on a forwarding policy that is independent of a suffix of the LDAP entry and the read or write operation; and
forwarding the request to the destination server.

2. The method of claim 1, wherein determining a destination server further comprises:
maintaining a forwarding map that maps an object class of the LDAP entries to one or more forwarding destinations.

3. The method of claim 1, wherein determining a destination server further comprises:
maintaining a forwarding map that maps a characteristic of a source of the request to one or more forwarding destinations.

4. The method of claim 1, wherein determining a destination server further comprises:
determining the destination server based on a service quality of the destination server.

5. The method of claim 1, wherein determining a destination server further comprises:
determining the destination server based on a group membership of a user that submits the request.

6. The method of claim 1, wherein determining a destination server further comprises:
determining the destination server based on a connection from which the request arrives.

7. The method of claim 1, wherein determining a destination server further comprises:
determining the destination server based on a security level of a source from which the request is submitted.

8. The method of claim 1, wherein determining a destination server further comprises:
determining the destination server based on an address from which the request is submitted.

9. A system comprising:
a plurality of repositories to store Light Weight Directory Access Protocol (LDAP) entries; and
a plurality of directory servers coupled to the repositories, each directory server to receive a request indicating a read or write operation for one of the LDAP entries, and to forward the request to a destination server of the directory servers based on a forwarding policy that is independent of a suffix of the LDAP entries and the read or write operation.

10. The system of claim 9, wherein each of the directory servers further comprises:
a front end to receive the request, forward the request to the destination server, and return results of the request received from the destination server; and
a back end to consult a forwarding map to determine the destination server.

11. The system of claim 9, wherein each of the directory servers further comprises:
an update unit to dynamically update a forwarding map based on a service quality of the destination server.

12. The system of claim 9, wherein each of the directory servers is to maintain a forwarding map that maps an object class of the LDAP entries to one or more forwarding destinations.

13. The system of claim 9, wherein each of the directory servers is to maintain a forwarding map that maps a characteristic of a source of the request to one or more forwarding destinations.

14. An article of manufacture, comprising:
a machine-accessible storage medium including data that, when accessed by a machine, cause the machine to perform a method comprising:
receiving, at a directory server, a request pertaining to a Light Weight Directory Access Protocol (LDAP) entry, the request indicating a read or write operation for the LDAP entry;
determining a destination server based on a forwarding policy that is independent of a suffix of the LDAP entry and the read or write operation; and
forwarding the request to the destination server.

15. The article of manufacture of claim 14, wherein determining a destination server further comprises:
determining the destination server based on a service quality of the destination server.

16. The article of manufacture of claim 14, wherein determining a destination server further comprises:
maintaining a forwarding map that maps an object class of the LDAP entries to one or more forwarding destinations.

17. The article of manufacture of claim 14, wherein determining a destination server further comprises:
maintaining a forwarding map that maps a characteristic of a source of the request to more or more forwarding destinations.

18. The article of manufacture of claim 14, wherein determining a destination server further comprises:
determining the destination server based on a group membership of a user that submits the request.

19. The article of manufacture of claim 14, wherein determining a destination server further comprises:
determining the destination server based on a connection from which the request arrives.

20. The article of manufacture of claim 14, wherein determining a destination server further comprises:
determining the destination server based on a security level of a source from which the request is submitted.
